(19) United States
(12) Patent Application Publication
(10) Pub. No.: US 2025/0306521 A1
(43) Pub. Date: Oct. 2, 2025

(54) IMAGE FORMING APPARATUS

(71) Applicant: FUJIFILM Business Innovation Corp., Tokyo (JP)

(72) Inventor: Motoki Matsushima, Kanagawa (JP)

(73) Assignee: FUJIFILM Business Innovation Corp., Tokyo (JP)

(21) Appl. No.: 18/808,528

(22) Filed: Aug. 19, 2024

(30) Foreign Application Priority Data
Mar. 26, 2024 (JP) 2024-049228

(51) Int. Cl. G03G 21/00; G03G 15/01; G03G 15/02; G03G 21/12

(52) U.S. Cl. CPC G03G 21/0011; G03G 15/0121; G03G 15/0189; G03G 15/0216; G03G 21/12

(57) ABSTRACT

An image forming apparatus includes: a first image forming unit that forms a toner image on an image carrier using colored toner containing no metallic pigment and that collects waste toner removed from the image carrier; a second image forming unit that forms a toner image on an image carrier using spot color toner having an average toner particle size greater than an average toner particle size of the colored toner by at least 20% or more and that collects waste toner removed from the image carrier; and an accumulating unit provided for each of the first image forming unit and the second image forming unit and configured such that when the waste toner removed from the image carrier is collected, an amount of the waste toner temporarily accumulated on the image carrier is substantially equal between the first image forming unit and the second image forming unit.

### CROSS-REFERENCE TO RELATED APPLICATIONS

This application is based on and claims priority under 35 USC 119 from Japanese Patent Application No. 2024-049228 filed Mar. 26, 2024.

### BACKGROUND

### (i) Technical Field

The present disclosure relates to an image forming apparatus.

### (ii) Related Art

A known waste-toner-collecting device includes plural waste-toner-collecting units, a collecting box that stores waste toners collected by the waste-toner-collecting units, and a waste toner transport path that transports the waste toners collected by the waste-toner-collecting units to the collecting box. Among the plural waste-toner-collecting units, a waste-toner-collecting unit that collects waste toner with low flowability is connected to the waste toner transport path at a position downstream of the positions at which the other waste-toner-collecting units are connected (Japanese Unexamined Patent Application Publication No. 2006-91038).

A known image forming apparatus includes a black image carrier that holds a black toner image, a yellow image carrier that holds a yellow toner image, a magenta image carrier that holds a magenta toner image, a cyan image carrier that holds a cyan toner image, a spot-color image carrier that holds a toner image of a spot color other than black, yellow, magenta, and cyan, and plural collecting units, each of which collects waste toner. The collecting units include a first collecting unit that collects waste toner removed from the black image carrier and waste toner removed from the spot-color image carrier (Japanese Unexamined Patent Application Publication No. 2021-157051).

### SUMMARY

Aspects of non-limiting embodiments of the present disclosure relate to collection of waste toners removed from plural image carriers with reduced variations in the amount of waste toner temporarily accumulated on each image carrier.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a first image forming unit that forms a toner image on an image carrier using colored toner containing no metallic pigment and that collects waste toner removed from the image carrier; a second image forming unit that forms a toner image on an image carrier using spot color toner having an average toner particle size greater than an average toner particle size of the colored toner by at least 20% or more and that collects waste toner removed from the image carrier; and an accumulating unit provided for each of the first image forming unit and the second image forming unit and configured such that when the waste toner removed from the image carrier is collected, an amount of the waste toner temporarily accumulated on the image carrier is substantially equal between the first image forming unit and the second image forming unit.

### BRIEF DESCRIPTION OF THE DRAWINGS

An exemplary embodiment of the present disclosure will be described in detail based on the following figures, wherein:

FIG. 1 is a schematic sectional view illustrating an example of the structure of an image forming apparatus;

FIG. 2 is a vertical schematic sectional view of a photoconductor unit and a developing device;

FIG. 3A is a schematic sectional view illustrating an operation of forming an image on a colored paper sheet or a transparent label in the image forming apparatus, and FIG. 3B illustrates an example of an image structure formed on a recording medium, which is the colored paper sheet or the transparent label;

FIG. 4A is a schematic sectional view of a bright toner particle taken along a thickness direction, and FIG. 4B is a schematic sectional view illustrating the reflection of light by bright toner that is fixed;

FIG. 5 is a schematic sectional view illustrating the structure of a cleaning device of the photoconductor unit;

FIG. 6 is a schematic diagram illustrating an example of a blocking member;

FIG. 7 is a schematic sectional view illustrating the structure around a cleaning blade of the cleaning device and a toner accumulation;

FIG. 8 illustrates the toner accumulation when the thickness of the blocking member is changed;

FIG. 9 illustrates the toner accumulation when an opening defined by the blocking member is changed;

FIG. 10 illustrates the toner accumulation when the distance between the blocking member and the photoconductor drum is changed; and

FIG. 11 illustrates the toner accumulation when the angle of the blocking member relative to the vertical direction is changed.

### DETAILED DESCRIPTION

The present disclosure will be described in further detail by way of exemplary embodiments and examples with reference to the drawings. However, the present disclosure is not limited to the exemplary embodiments and examples.

It is to be noted that the drawings referred to in the following description are schematic, and that dimensional ratios, for example, in the drawings differ from the actual ones. Components other than those necessary for description to facilitate understanding are omitted as appropriate in the drawings.

### (1) Overall Structure and Operation of Image Forming Apparatus

### (1.1) Overall Structure of Image Forming Apparatus

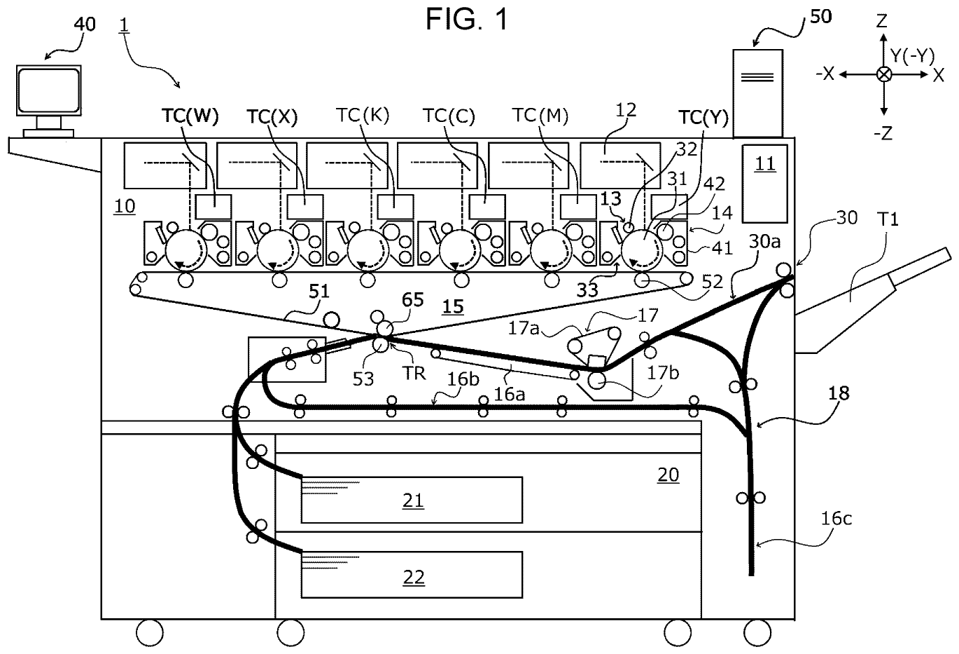

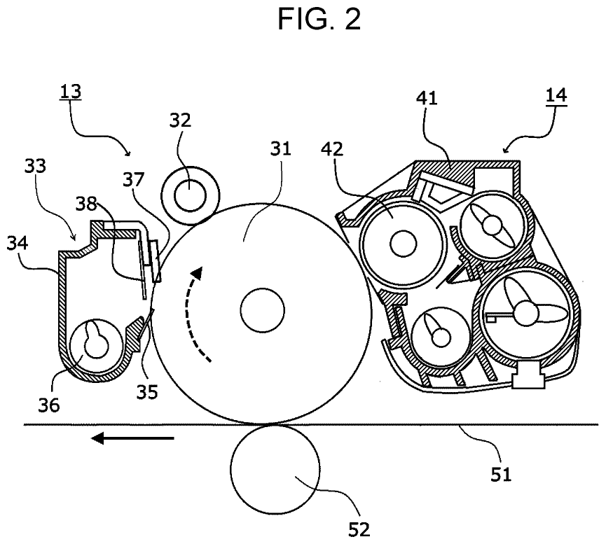

FIG. 1 is a schematic sectional view illustrating an example of the structure of an image forming apparatus 1 according to the present exemplary embodiment. FIG. 2 is a vertical schematic sectional view of a photoconductor unit 13 and a developing device 14.

The image forming apparatus 1 includes an image forming section 10; a sheet feeding device 20 attached to the bottom of the image forming section 10; a sheet output unit 30 that is provided on one end of the image forming section 10 and to which a printed paper sheet is output; an operation display 40; and an image processing unit 50 that generates image information based on printing information transmitted from a high-order device.

The image forming section 10 includes a system control device 11, exposure devices 12, photoconductor units 13, developing devices 14, a transfer device 15, sheet transporting devices 16a, 16b, and 16c, and a fixing device 17. The image forming section 10 forms a toner image based on image information received from the image processing unit 50 on a recording medium fed from the sheet feeding device 20.

The sheet feeding device 20 supplies recording media to the image forming section 10. The sheet feeding device 20 includes plural sheet trays that store recording media of different types (for example, different materials, thicknesses, sizes, or grain directions), and is configured to supply a recording medium fed from one of the sheet trays to the image forming section 10.

The sheet output unit 30 outputs a recording medium on which an image is formed by the image forming section 10. Therefore, the sheet output unit 30 includes a sheet receiver T1 that receives the recording medium output after the image is formed thereon. The sheet output unit 30 may have a function of performing post-processing, such as cutting or stapling (staple binding), on a stack of paper sheets output from the image forming section 10.

The operation display 40 is used to input various settings and instructions and display information. The operation display 40 corresponds to a user interface, and is obtained by combining, for example, a liquid crystal display panel, various operation buttons, and a touch panel together.

### (1.2) Structure and Operation of Image Forming Section

In the image forming apparatus 1 having the above-described structure, a recording medium is fed to the image forming section 10 in accordance with the timing of image formation from one of the sheet trays of the sheet feeding device 20 specified for each page of a print job.

The photoconductor units 13 (Y, M, C, K, X, and W: simply referred to as photoconductor units 13 when distinction therebetween is not necessary) include photoconductor drums 31 that are arranged parallel to each other below the exposure devices 12 and that serve as rotatable image carriers. Each photoconductor drum 31 is surrounded by a charging roller 32, an exposure device 12, a developing device 14, a first transfer roller 52, and a cleaning device 33, which are arranged around in that order in the rotation direction (shown by the arrows in FIG. 1) of the photoconductor drum 31. The cleaning device 33 includes a cleaning blade 37 that removes toner remaining on the photoconductor drum 31. The cleaning blade 37 is in contact with a surface of the photoconductor drum 31 and scrapes off the toner remaining on the surface of the photoconductor drum 31. In the following description, the cleaning devices 33 provided on the photoconductor units 13Y, 13M, 13C, 13K, 13X, and 13W may be referred to as cleaning devices 33Y, 33M, 33C, 33K, 33X, and 33W.

The photoconductor units 13Y, 13M, 13C, and 13K respectively form images of yellow (Y), magenta (M), cyan (C), and black (K) (colors of colored toners containing no metallic pigment may be hereinafter referred to as ordinary colors). The photoconductor unit 13X forms an image of a spot color different from the ordinary colors. Here, the spot color is a color that is different from the ordinary colors, for example, a color that is not easily produced by the toners of the ordinary colors, that is, yellow (Y), magenta (M), cyan (C), and black (K). Specific examples of the spot color include metallic colors, such as gold and silver, produced by bright toners containing metallic pigments. The photoconductor unit 13W forms a white toner image using white toner (W). In FIG. 1, the photoconductor unit 13X and the photoconductor unit 13W are disposed next to each other in a region downstream of the photoconductor unit 13K in the direction in which an intermediate transfer belt 51 moves. However, the photoconductor units 13X and 13W may be disposed in an individually selectable and replaceable manner depending on the image to be formed. The spot color is not limited to a metallic color, and may be, for example, red, green, or blue. In any case, the toner of a spot color has an average toner particle size greater than those of the toners of the ordinary colors by at least 20% or more, and is known to have a flowability lower than those of the toners of the ordinary colors.

Each developing device 14 includes a developing housing 41 containing developer. A developing roller 42, which opposes the corresponding photoconductor drum 31, is disposed in the developing housing 41. The developing roller 42 has a developer layer with a regulated thickness provided thereon, and forms a toner image on the photoconductor drum 31.

The developing devices 14 (Y, M, C, K, X, and W: simply referred to as developing devices 14 when distinction therebetween is not necessary) have substantially the same structures except for the developers contained in the developing housings 41 thereof, and form toner images of yellow (Y), magenta (M), cyan (C), black (K), spot color (X), and white (W).

Replaceable toner cartridges TC that contain the toners and toner supply devices (not illustrated) that supply the toners and carrier from the toner cartridges TC to the developing devices 14 are disposed above the developing devices 14.

The surfaces of the photoconductor drums 31 that rotate are charged by the respective charging rollers 32, and electrostatic latent images are formed thereon by latent-image-forming light emitted from the respective exposure devices 12. The electrostatic latent images formed on the photoconductor drums 31 are developed into toner images by the respective developing rollers 42.

The transfer device 15 includes the intermediate transfer belt 51, first transfer rollers 52, and a second transfer roller 53. The toner images of the respective colors formed on the photoconductor drums 31 of the photoconductor units 13 are transferred to the intermediate transfer belt 51 in a superposed manner. The first transfer rollers 52 successively transfer the toner images of the respective colors formed by the photoconductor units 13 to the intermediate transfer belt 51 (first transfer process). The second transfer roller 53 simultaneously transfers the toner images of the respective colors superposed on the intermediate transfer belt 51 to a recording medium (second transfer process).

The toner images of the respective colors formed on the photoconductor drums 31 of the photoconductor units 13 are successively electrostatically transferred to the intermediate transfer belt 51 by the first transfer rollers 52 to which a predetermined transfer voltage is applied by, for example, a power supply (not illustrated) controlled by the system control device 11 (first transfer process). Thus, a superposed toner image in which the toner images of the respective colors are superposed is formed.

As the intermediate transfer belt 51 is moved, the superposed toner image on the intermediate transfer belt 51 is transported to a second transfer unit TR at which the second transfer belt 53 is pressed against the backup roller 65 with the intermediate transfer belt 51 interposed therebetween.

When the superposed toner image is transported to the second transfer unit TR, the recording medium is supplied to the second transfer unit TR from the sheet feeding device 20 at the same time. The backup roller 65, which opposes the second transfer roller 53 with the intermediate transfer belt 51 interposed therebetween, receives a predetermined second transfer voltage from a power supply (not illustrated) controlled by the system control device 11. Thus, the toner images superposed on the intermediate transfer belt 51 are simultaneously transferred to the recording medium.

The toner that remains on the surface of each photoconductor drum 31 is removed by the cleaning blade 37 of the corresponding cleaning device 33 and is collected in a waste toner storage box (not illustrated). The surface of each photoconductor drum 31 is charged again by the corresponding charging roller 32.

The fixing device 17 includes an endless fixing belt 17a that rotates in one direction and a pressing roller 17b that is in contact with the peripheral surface of the fixing belt 17a and that rotates in one direction. The region in which the fixing belt 17a and the pressing roller 17b are pressed against each other serves as a nip portion (fixing region).

The recording medium to which the toner images have been transferred by the transfer device 15 is transported to the fixing device 17 by the sheet transporting device 16a while the toner images are unfixed. The recording medium transported to the fixing device 17 is pressed and heated by the fixing belt 17a and the pressing roller 17b, so that the toner images are fixed thereto.

After the fixing process, the recording medium is transported to the sheet output unit 30 and placed on the sheet receiver T1. The recording medium is subjected to post-processing, such as cutting or stapling (staple bonding), as necessary.

### (1.3) Formation of Image on Non-white Colored or Transparent Recording Medium

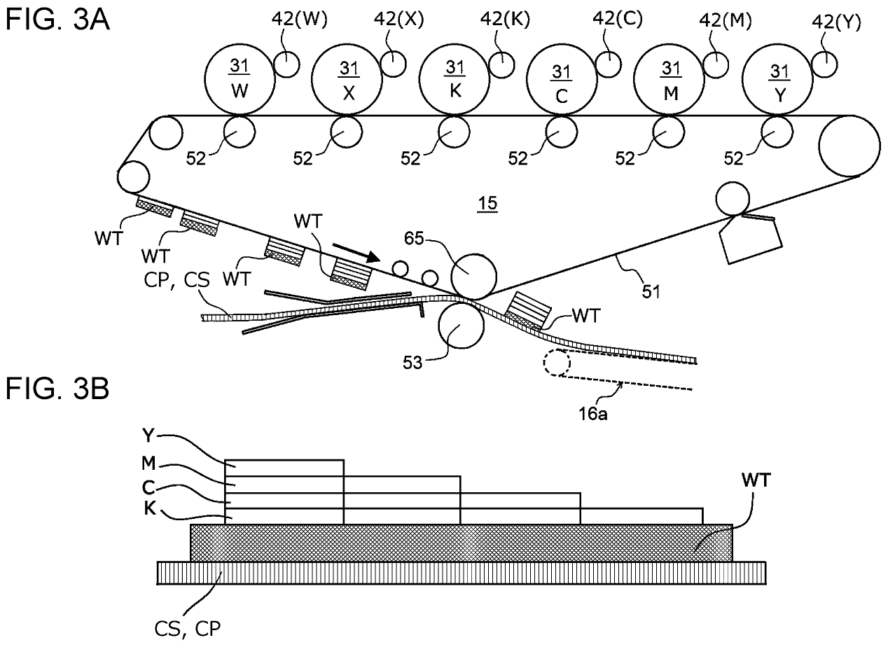

FIG. 3A is a schematic sectional view illustrating an operation of forming an image on a colored paper sheet CP or a transparent label CS in the image forming apparatus 1, and FIG. 3B illustrates an example of an image structure formed on a recording medium, which is the colored paper sheet CP or the transparent label CS.

The image forming apparatus 1 according to the present exemplary embodiment forms a color image including yellow toner (Y), magenta toner (M), cyan toner (C), and black toner (K), which are the toners of the ordinary colors, on the colored paper sheet CP, which is a recording medium having a color other than white, such as black, blue, or red, or the transparent label CS.

An image forming operation can be performed so that white toner (W), which is the toner of a spot color other than the ordinary colors, is used to form a white toner image WT at the lowermost layer on the image forming surface of the colored paper sheet CP or the transparent label CS on which a color image is formed. The white toner (W) has an average toner particle size greater than those of the toners of the ordinary colors (Y, M, C, and K) by at least 20% or more, thereby more effectively covering the colored paper sheet CP and the transparent label CS.

As illustrated in FIG. 3A, in the image forming apparatus 1, the photoconductor unit 13W and the developing device 14W, which constitute a second image forming unit for forming the white toner image WT using the white toner (W), are disposed downstream of the photoconductor units 13Y, 13M, 13C, and 13K and the developing devices 14Y, 14M, 14C, and 14K, which constitute first image forming units for forming a superposed toner image (YMCK) of respective colors using the toners of yellow (Y), magenta (M), cyan (C), and black (K) as the ordinary colors, in the direction in which the intermediate transfer belt 51 rotates.

When the image forming apparatus 1 having the above-described structure transfers an image on the intermediate transfer belt 51 to the colored paper sheet CP or the transparent label CS, first, a superposed toner image is formed by successively transferring color images of respective colors, which are yellow (Y), magenta (M), cyan (C), and black (K), to the intermediate transfer belt 51. Then, the white toner image (WT) is transferred onto the superposed toner image (YMCK) in the first transfer process. The colored paper sheet or the transparent label is fed from the sheet feeding device 20 to the second transfer unit (TR), and the color image having the white toner image WT that has been transferred to the outer peripheral surface of the intermediate transfer belt 51 in the first transfer process is transferred to the colored paper sheet or the transparent label in the second transfer process.

Thus, as schematically illustrated in FIG. 3B, a recording medium is formed in which the superposed toner image (YMCK) formed by superposing the color images of respective colors is formed on the white toner image that covers the background color of the colored paper sheet. Alternatively, a recording medium is formed in which the superposed toner image (YMCK) formed by superposing the color images of respective colors is formed on the white toner image that covers the transparent label CS to prevent transmission of light.

### (1.4) Formation of Metallic Image

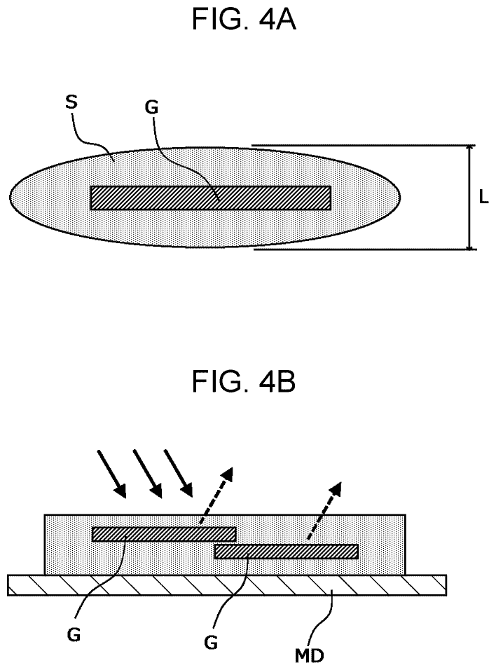

FIG. 4A is a schematic sectional view of a bright toner particle A taken along a thickness direction, and FIG. 4B is a schematic sectional view illustrating the reflection of light by bright toner that is fixed.

In the present exemplary embodiment, the photoconductor unit 13X and the developing device 14X, which form an image of the spot color (X) as necessary, are disposed downstream of the photoconductor units 13Y, 13M, 13C, and 13K and the developing devices 14Y, 14M, 14C, and 14K for the ordinary colors in the direction in which the intermediate transfer belt 51 rotates. The toner of the spot color (X) may be, for example, bright toner that contains a metallic pigment, a predetermined pigment, and a binder resin and adds a metallic luster to the image.

As schematically illustrated in FIG. 4A, the bright toner includes bright toner particles S, each of which has an equivalent circle diameter longer than a thickness L thereof and contains a scalelike piece of metallic pigment G, which is an example of a bright pigment. Each particle of the bright toner, such as gold or silver toner, has a flat shape so that the piece of bright pigment contained therein extends parallel to the long-axis direction thereof. Therefore, the pieces of the bright pigment contained in the toner transferred to a medium MD, such as paper or a film, are parallel to the medium, so that the reflection of light by the pigment in the fixed image is increased, as illustrated in FIG. 4B. Thus, the brightness is increased and a metallic luster is created.

When a metallic image is formed using the bright toner, first, the toners of yellow (Y), magenta (M), cyan (C), black (K), and the spot color (X) of gold or silver (bright toner) are successively transferred to the intermediate transfer belt 51. A recording medium is fed from the sheet feeding device 20 to the second transfer unit (TR), and the color image having the spot-color toner image that has been transferred to the outer peripheral surface of the intermediate transfer belt 51 in the first transfer process is transferred to the recording medium in the second transfer process. Subsequently, the image is fixed by being heated and pressed in the fixing device 17.

### (2) Cleaning Device

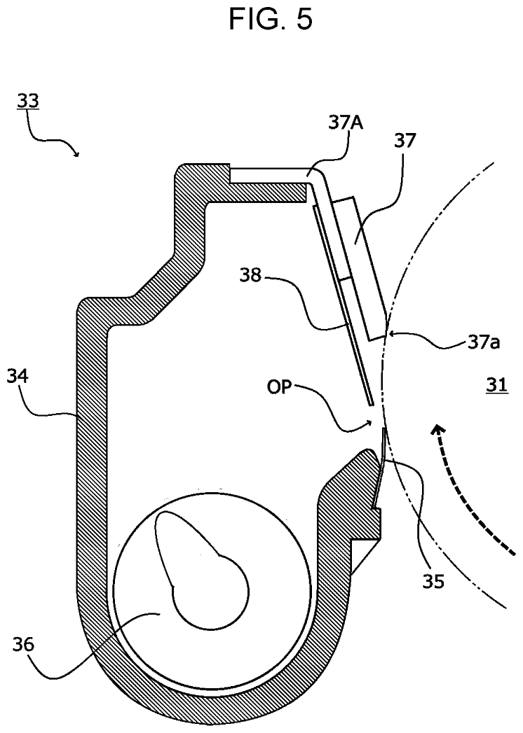

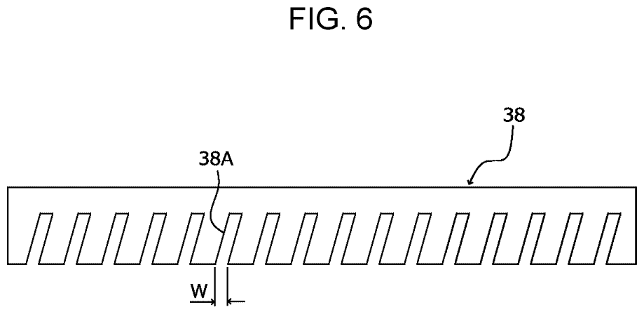

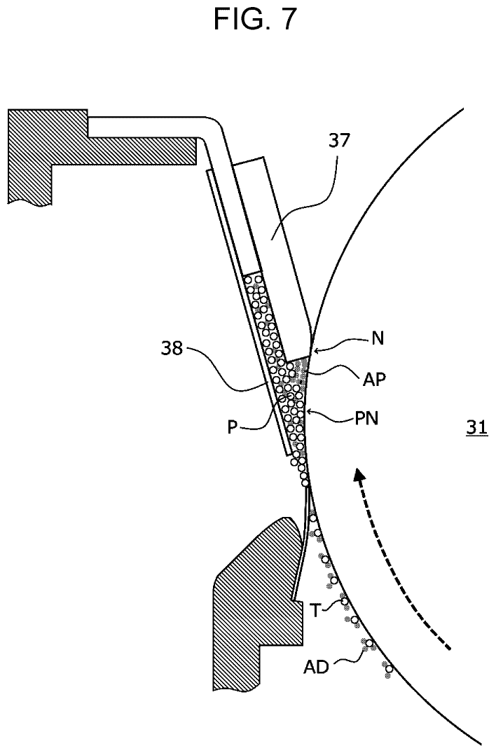

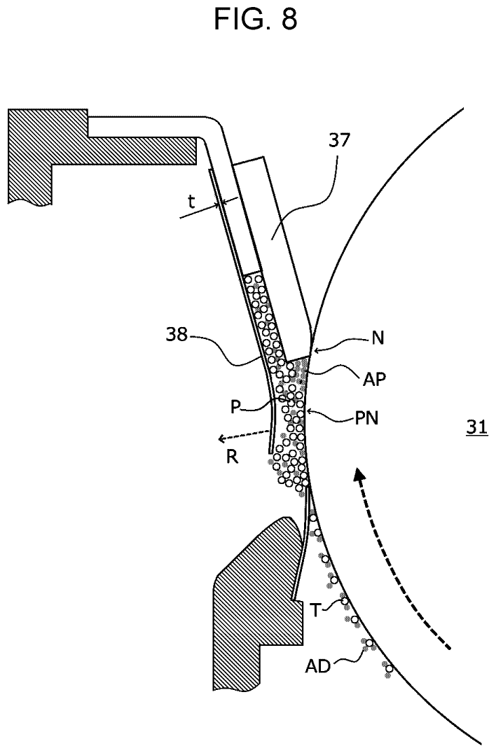

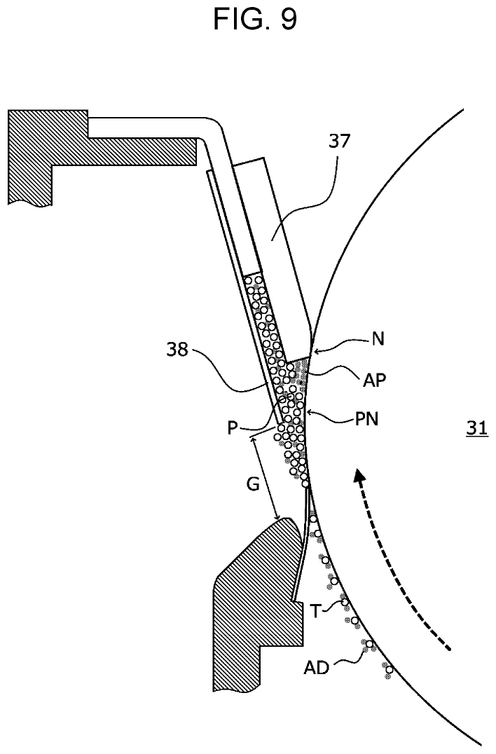

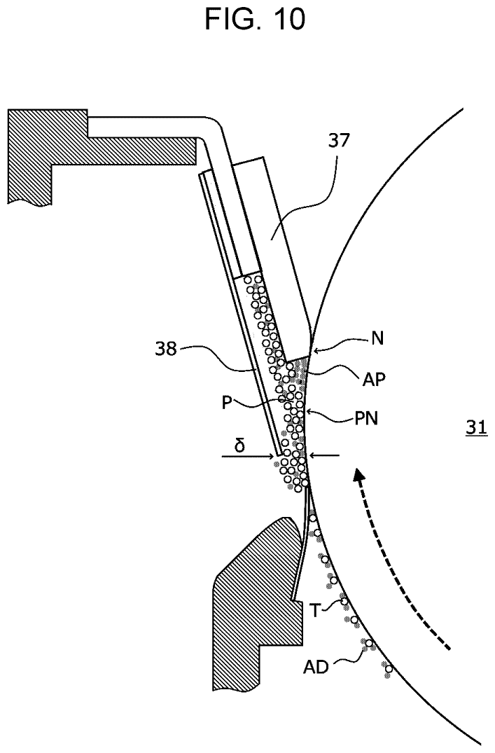

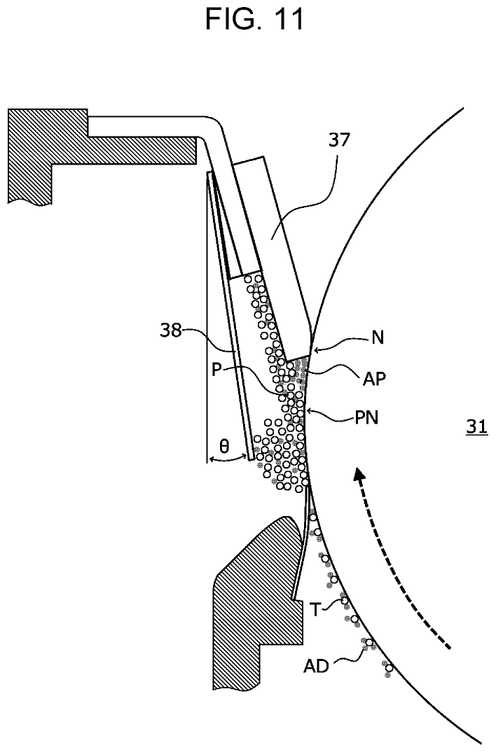

FIG. 5 is a schematic sectional view illustrating the structure of the cleaning device 33 of each photoconductor unit 13. FIG. 6 is a schematic diagram illustrating an example of a blocking member 38. FIG. 7 is a schematic sectional view illustrating the structure around the cleaning blade 37 of the cleaning device 33 and a toner accumulation. FIG. 8 illustrates the toner accumulation when the thickness of the blocking member 38 is changed. FIG. 9 illustrates the toner accumulation when an opening G defined by the blocking member 38 is changed. FIG. 10 illustrates the toner accumulation when the distance between the blocking member 38 and the photoconductor drum 31 is changed. FIG. 11 illustrates the toner accumulation when an angle θ of the blocking member 38 relative to the vertical direction is changed.

The collection of residual toner from the image forming apparatus 1 including the photoconductor units 13 and the developing devices 14 for the spot colors in addition to the ordinary colors will be described with reference to the drawings.

### (2.1) Structure of Cleaning Device

The cleaning device 33 includes a housing 34 positioned to face the photoconductor drum 31; a sealing member 35 supported at a lower edge of an opening formed in the housing 34; a toner collecting auger 36 that transports waste toner collected in the housing 34; a cleaning blade 37 that is in contact with the surface of the photoconductor drum 31 and scrapes off substances to be collected from the photoconductor drum 31; and a blocking member 38, which is an example of a sheet body. The blocking member 38 is provided on an end portion of a support member 37A, which fixes and supports the cleaning blade 37 on the housing 34, at a side opposite to the side at which the cleaning blade 37 is provided.

The cleaning device 33 is integrated with the photoconductor drum 31 and other components into a unit as the photoconductor unit 13, which is removably attachable to the image forming apparatus 1.

The housing 34 temporarily stores the toner, paper dust, etc., removed from the surface of the photoconductor drum 31 by the cleaning blade 37, and has an opening OP positioned to face the photoconductor drum 31. The cleaning blade 37 and the sealing member 35 are provided in the opening OP and are in contact with the photoconductor drum 31.

The sealing member 35 is fixed and supported at the lower end of the opening in the housing 34, and seals the gap between the photoconductor drum 31 and the housing 34 to prevent leakage of the toner collected in the cleaning device 33 to the outside of the cleaning device 33. The sealing member 35 may be, for example, a thermoplastic polyurethane film having a thickness of 0.1 mm.

The toner collecting auger 36 is composed of a screw, and transports the waste toner and other substances removed from the surface of the photoconductor drum 31 and stored in the housing 34 to a waste toner box (not illustrated) while stirring the waste toner and other substances.

The cleaning blade 37 is made of a material having good mechanical properties, such as abrasion resistance, chipping resistance, and creep resistance. For example, the cleaning blade 37 is made of a urethane rubber, such as thermosetting polyurethane rubber, and is fixed and supported on the housing 34 by the support member 37A that is L-shaped in cross section. The cleaning blade 37 has an end portion 37a that is in contact with the surface of the photoconductor drum 31 at a predetermined contact pressure to remove the toner, paper dust, etc., from the surface of the photoconductor drum 31.

The blocking member 38 blocks the toner scrapped off from the surface of the photoconductor drum 31 and causes the toner to accumulate in a region upstream of the contact position between the cleaning blade 37 and the photoconductor drum 31 in the direction in which the photoconductor drum 31 rotates (direction shown by the arrow in the figures).

As described below, the blocking member 38 is a sheet body having a predetermined thickness, and the width thereof in the longitudinal direction (length in the axial direction of the photoconductor drum 31) is adjusted to be substantially equal to the width of the cleaning blade 37 in the longitudinal direction.

Examples of the material of the blocking member 38 include resins, such as polyethylene terephthalate (PET), polyethylene (PE), polypropylene (PP), and polyurethane (PU). In particular, the material may be polyethylene terephthalate (PET).

As described below, the thickness of the blocking member 38 may be set in accordance with the type of the toner to be collected, more specifically, whether the toner to be collected is the toner of an ordinary color or the toner of a spot color.

As illustrated in FIG. 6, an end portion of the blocking member 38 has cuts 38A (slits) with a cutting width W arranged at equal intervals over the entire region thereof in the longitudinal direction.

Thus, some of the toner caused to accumulate in the toner accumulation by the blocking member 38 passes through the cuts, so that replacement of the toner easily occurs. Therefore, the aggregation of the toner particles and the aggregation of an external additive may be suppressed, and the cleaning performance may be easily improved.

As described below, in the present exemplary embodiment, the cutting width W of the cuts 38A may be set in accordance with the type of the toner to be collected, more specifically, whether the toner to be collected is the toner of an ordinary color or the toner of a spot color.

### (2.2) Operation of Cleaning Device

The cleaning device 33 removes substances collected from the photoconductor drum 31 after the toner image is transferred to the intermediate transfer belt 51 in the first transfer process. The collected substances include residual developer (toner and external additive) and foreign matter, such as paper dust that has adhered to the photoconductor drum 31 from the recording medium.

The cleaning blade 37 has an end corner 37a that is in contact with the surface of the photoconductor drum 31 at an acute angle relative to the direction in which the photoconductor drum 31 rotates (doctor blade method) to form a cleaning nip portion N (hereinafter simply referred to as nip portion N) and scrape off and remove the substances to be collected from the photoconductor drum 31.

As illustrated in FIG. 7, when the photoconductor drum 31 rotates in the direction shown by the arrow, residual toner T (shown by white circles) that has not been transferred is stopped at an end of the nip portion N (region upstream of the contact portion between the cleaning blade 37 and the photoconductor drum 31 in the direction in which the photoconductor drum 31 rotates; hereinafter also referred to as a “pre-nip region PN”), and forms a toner accumulation P surrounded by the blocking member 38, the cleaning blade 37, and the surface of the photoconductor drum 31.

When toner having an external additive AD added to the toner particles is used in the image forming apparatus 1, the external additive AD is released from the toner particles due to the influence of an external force, such as mechanical load applied during stirring in the developing device 14 or mechanical load applied when the toner is scraped off in the cleaning nip portion. When the released external additive AD (shown by meshed dots) reaches the nip portion N, the additive AD is stopped in the pre-nip region PN at a position closer to the contact portion between the cleaning blade 37 and the photoconductor drum 31 than the toner accumulation P and forms an aggregate (hereinafter also referred to as “external additive accumulation AP” due to pressure applied by the cleaning blade 37. The external additive accumulation AP is known to improve the cleaning performance (performance of scraping off the toner).

The cleaning device 33 according to the present exemplary embodiment includes the blocking member 38 positioned on the back side of the cleaning blade 37. Therefore, compared to when the blocking member 38 is not provided, a larger amount of toner tends to accumulate in the toner accumulation P, and a larger amount of external additive AD tends to be supplied to the external additive accumulation AP formed at a position closer to the contact portion of the photoconductor drum 31 in the nip portion PN. Accordingly, the external additive accumulation AP is reliably and more easily formed at the end of the nip portion N, and the lubricity in the nip portion N can be increased.

In the photoconductor unit 13W and the photoconductor unit 13X serving as the second image forming units, the white toner (W) and the bright toner (X) that differ from the toners of yellow (Y), magenta (M), cyan (C), and black (K), which are ordinary colors, are used. The white toner (W) has an average toner particle size greater than those of the toners of the ordinary colors (Y, M, C, and K) by at least 20% or more, and is known to have a flowability lower than those of the toners of the ordinary colors (Y, M, C, and K). In addition, as schematically illustrated in FIG. 4A, each particle of the bright toner (X) has a flat shape so that the piece of bright pigment G therein extends parallel to the long-axis direction thereof. The particles of the bright toner (X) typically have an average length of 7 μm or more and 20 μm or less in the long-axis direction and an average thickness of 1 μm or more and 3 μm or less. Therefore, the bright toner (X) is known to have a higher unconfined yield stress and a lower flowability than the toners of the ordinary colors (Y, M, C, and K). Therefore, in the photoconductor unit 13W in which the white toner (W) is used and the photoconductor unit 13X in which the bright toner (X) is used, the amount of toner accumulated in the toner accumulation P is greater than those in the photoconductor units 13Y, 13M, 13C, and 13K in which the toners of the ordinary colors (Y, M, C, and K) are used. Accordingly, the toner is not easily collected in the housing 34, and there is a possibility that the toner will fall in lumps.

In the present exemplary embodiment, the cleaning device 33 is provided. The cleaning device 33 is configured such that when the residual toner removed from the photoconductor drum 31 (residual toner collected by the cleaning blade is also referred to as “waste toner”) is collected, the amount of the waste toner temporarily accumulated on the photoconductor drum 31 is substantially equal between the photoconductor units 13Y, 13M, 13C, and 13K serving as the first image forming units and the photoconductor units 13W and 13X serving as the second image forming units.

More specifically, a toner accumulation space is defined by the photoconductor drum 31, the cleaning blade 37 that is in contact with the surface of the photoconductor drum 31 to scrape off the waste toner, and the blocking member 38 that faces the photoconductor drum 31 and defines the opening G through which the waste toner is discharged. The amount of the waste toner scraped off by the cleaning blade 37 and temporarily accumulated in the toner accumulation space is made substantially equal between the photoconductor units 13Y, 13M, 13C, and 13K and the photoconductor units 13W and 13X.

More specifically, as illustrated in FIG. 8, the blocking member 38 in each of the photoconductor units 13W and 13X may be formed to have a smaller thickness t than the blocking member 38 in each of the photoconductor units 13Y, 13M, 13C, and 13K, so that the blocking member 38 is more easily bent toward the housing 34 (see arrow R in FIG. 8) to reduce the amount of the waste toner temporarily accumulated in the toner accumulation space and make the amount of the temporarily accumulated waste toner substantially equal. Thus, the amount of the temporarily accumulated waste toner in the photoconductor units 13W and 13X may be prevented from being increased.

Alternatively, the blocking member 38 in each of the photoconductor units 13W and 13X may be formed such that the cutting width W (see W in FIG. 6) is greater than the cutting width W of the blocking member 38 in each of the photoconductor units 13Y, 13M, 13C, and 13K to reduce the amount of the waste toner temporarily accumulated in the toner accumulation space and make the amount of the temporarily accumulated waste toner substantially equal. Thus, the amount of the temporarily accumulated waste toner in the photoconductor units 13W and 13X may be prevented from being increased.

Alternatively, as illustrated in FIG. 9, the blocking member 38 in each of the photoconductor units 13W and 13X may be formed to define the opening G greater than the opening defined by the blocking member 38 in each of the photoconductor units 13Y, 13M, 13C, and 13K to reduce the amount of the waste toner temporarily accumulated in the toner accumulation space and make the amount of the temporarily accumulated waste toner substantially equal. Thus, the amount of the temporarily accumulated waste toner in the photoconductor units 13W and 13X may be prevented from being increased.

Alternatively, as illustrated in FIG. 10, the blocking member 38 in each of the photoconductor units 13W and 13X may be spaced from the photoconductor drum 31 by a distance 8 greater than the distance by which the blocking member 38 in each of the photoconductor units 13Y, 13M, 13C, and 13K is spaced from the photoconductor drum 31, so that the amount of the waste toner temporarily accumulated on the photoconductor drum 31 is substantially equal. Thus, the amount of the temporarily accumulated waste toner in the photoconductor units 13W and 13X may be prevented from being increased.

Alternatively, the blocking member 38 in each of the photoconductor units 13W and 13X may be formed to have a Young's modulus less than the Young's modulus of the blocking member 38 in each of the photoconductor units 13Y, 13M, 13C, and 13K to reduce the amount of the waste toner temporarily accumulated on the photoconductor drum 31 and make the amount of the temporarily accumulated waste toner substantially equal. Thus, the amount of the temporarily accumulated waste toner in the photoconductor units 13W and 13X may be prevented from being increased.

Alternatively, as illustrated in FIG. 11, the blocking member 38 in each of the photoconductor units 13W and 13X is positioned such that an angle θ relative to the vertical direction is less than an angle θ of the blocking member 38 relative to the vertical direction in each of the photoconductor units 13Y, 13M, 13C, and 13K to reduce the amount of the waste toner temporarily accumulated on the photoconductor drum 31 and make the amount of the temporarily accumulated waste toner substantially equal. Thus, the amount of the temporarily accumulated waste toner in the photoconductor units 13W and 13X may be prevented from being increased.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1) An image forming apparatus including:
   a first image forming unit that forms a toner image on an image carrier using colored toner containing no metallic pigment and that collects waste toner removed from the image carrier;
   a second image forming unit that forms a toner image on an image carrier using spot color toner having an average toner particle size greater than an average toner particle size of the colored toner by at least 20% or more and that collects waste toner removed from the image carrier; and
   an accumulating unit provided for each of the first image forming unit and the second image forming unit and configured such that when the waste toner removed from the image carrier is collected, an amount of the waste toner temporarily accumulated on the image carrier is substantially equal between the first image forming unit and the second image forming unit.
(((2))) The image forming apparatus according to (((1))),
   wherein the accumulating unit defines a space surrounded by the image carrier, a cleaning body that is in contact with a surface of the image carrier to scrape off the waste toner, and a sheet body that faces the image carrier to define an opening through which the waste toner is discharged, and the waste toner scraped off by the cleaning body is temporarily accumulated in the space.
(((3))) The image forming apparatus according to (((2))),
   wherein a thickness of the sheet body of the accumulating unit for the second image forming unit is less than a thickness of the sheet body of the accumulating unit for the first image forming unit so that the amount of the waste toner temporarily accumulated on the image carrier is substantially equal between the first image forming unit and the second image forming unit.
(((4))) The image forming apparatus according to (((2))) or (((3))),
   wherein a cutting width of the sheet body of the accumulating unit for the second image forming unit is greater than a cutting width of the sheet body of the accumulating unit for the first image forming unit so that the amount of the waste toner temporarily accumulated on the image carrier is substantially equal between the first image forming unit and the second image forming unit.
(((5))) The image forming apparatus according to any one of (((2))) to (((4))),
   wherein the opening in the accumulating unit of the second image forming unit is larger than the opening in the accumulating unit of the first image forming unit so that the amount of the waste toner temporarily accumulated on the image carrier is substantially equal between the first image forming unit and the second image forming unit.
(((6))) The image forming apparatus according to any one of (((2))) to (((5))),
   wherein a distance between the sheet body of the accumulating unit for the second image forming unit and the image carrier is greater than a distance between the sheet body of the accumulating unit for the first image forming unit and the image carrier so that the amount of the waste toner temporarily accumulated on the image carrier is substantially equal between the first image forming unit and the second image forming unit.
(((7))) The image forming apparatus according to any one of (((2))) to (((6))),
   wherein a Young's modulus of the sheet body of the accumulating unit for the second image forming unit is less than a Young's modulus of the sheet body of the accumulating unit for the first image forming unit so that the amount of the waste toner temporarily accumulated on the image carrier is substantially equal between the first image forming unit and the second image forming unit.
(((8))) The image forming apparatus according to any one of (((2))) to (((7))),
   wherein an angle of the sheet body of the accumulating unit for the second image forming unit relative to a vertical direction is less than an angle of the sheet body of the accumulating unit for the first image forming unit relative to the vertical direction so that the amount of the waste toner temporarily accumulated on the image carrier is substantially equal between the first image forming unit and the second image forming unit.
(((9))) The image forming apparatus according to any one of (((1))) to (((8))),
   wherein the image carrier is uniformly charged by contact charging.

What is claimed is:

1. An image forming apparatus comprising:
a first image forming unit that forms a toner image on an image carrier using colored toner containing no metallic pigment and that collects waste toner removed from the image carrier;
a second image forming unit that forms a toner image on an image carrier using spot color toner having an average toner particle size greater than an average toner particle size of the colored toner by at least 20% or more and that collects waste toner removed from the image carrier; and
an accumulating unit provided for each of the first image forming unit and the second image forming unit and configured such that when the waste toner removed from the image carrier is collected, an amount of the waste toner temporarily accumulated on the image carrier is substantially equal between the first image forming unit and the second image forming unit.

2. The image forming apparatus according to claim 1,
wherein the accumulating unit defines a space surrounded by the image carrier, a cleaning body that is in contact with a surface of the image carrier to scrape off the waste toner, and a sheet body that faces the image carrier to define an opening through which the waste toner is discharged, and the waste toner scraped off by the cleaning body is temporarily accumulated in the space.

3. The image forming apparatus according to claim 2,
wherein a thickness of the sheet body of the accumulating unit for the second image forming unit is less than a thickness of the sheet body of the accumulating unit for the first image forming unit so that the amount of the waste toner temporarily accumulated on the image carrier is substantially equal between the first image forming unit and the second image forming unit.

4. The image forming apparatus according to claim 2,
wherein a cutting width of the sheet body of the accumulating unit for the second image forming unit is greater than a cutting width of the sheet body of the accumulating unit for the first image forming unit so that the amount of the waste toner temporarily accumulated on the image carrier is substantially equal between the first image forming unit and the second image forming unit.

5. The image forming apparatus according to claim 2,
wherein the opening in the accumulating unit of the second image forming unit is larger than the opening in the accumulating unit of the first image forming unit so that the amount of the waste toner temporarily accumulated on the image carrier is substantially equal between the first image forming unit and the second image forming unit.

6. The image forming apparatus according to claim 2,
wherein a distance between the sheet body of the accumulating unit for the second image forming unit and the image carrier is greater than a distance between the sheet body of the accumulating unit for the first image forming unit and the image carrier so that the amount of the waste toner temporarily accumulated on the image carrier is substantially equal between the first image forming unit and the second image forming unit.

7. The image forming apparatus according to claim 2,
wherein a Young's modulus of the sheet body of the accumulating unit for the second image forming unit is less than a Young's modulus of the sheet body of the accumulating unit for the first image forming unit so that the amount of the waste toner temporarily accumulated on the image carrier is substantially equal between the first image forming unit and the second image forming unit.

8. The image forming apparatus according to claim 2,
wherein an angle of the sheet body of the accumulating unit for the second image forming unit relative to a vertical direction is less than an angle of the sheet body of the accumulating unit for the first image forming unit relative to the vertical direction so that the amount of the waste toner temporarily accumulated on the image carrier is substantially equal between the first image forming unit and the second image forming unit.

9. The image forming apparatus according to claim 1,
wherein the image carrier is uniformly charged by contact charging.

10. The image forming apparatus according to claim 2,
wherein the image carrier is uniformly charged by contact charging.

11. The image forming apparatus according to claim 3,
wherein the image carrier is uniformly charged by contact charging.

12. The image forming apparatus according to claim 4,
wherein the image carrier is uniformly charged by contact charging.

13. The image forming apparatus according to claim 5,
wherein the image carrier is uniformly charged by contact charging.

14. The image forming apparatus according to claim 6,
wherein the image carrier is uniformly charged by contact charging.

15. The image forming apparatus according to claim 7,
wherein the image carrier is uniformly charged by contact charging.

16. The image forming apparatus according to claim 8,
wherein the image carrier is uniformly charged by contact charging.

17. An image forming apparatus comprising:
first image forming means for forming a toner image on an image carrier using colored toner containing no metallic pigment and that collects waste toner removed from the image carrier;
second image forming means for forming a toner image on an image carrier using spot color toner having an average toner particle size greater than an average toner particle size of the colored toner by at least 20% or more and that collects waste toner removed from the image carrier; and
accumulating means provided for each of the first image forming means and the second image forming means and configured such that when the waste toner removed from the image carrier is collected, an amount of the waste toner temporarily accumulated on the image carrier is substantially equal between the first image forming means and the second image forming means.
